(19) United States
(12) Patent Application Publication
(10) Pub. No.: US 2010/0001060 A1
(43) Pub. Date: Jan. 7, 2010

(54) SELF-SERVICE DEVICE

(75) Inventor: Bernd Kruse, Altenbeken (DE)

Correspondence Address: HARNESS, DICKEY & PIERCE, P.L.C., P.O. BOX 828, BLOOMFIELD HILLS, MI, 48303, US

(73) Assignee: WINCOR NIXDORF INTERNATIONA GMBH, Paderborn (DE)

(21) Appl. No.: 12/525,509

(22) PCT Filed: Feb. 15, 2008
(86) PCT No.: PCT/EP2008/001144

§ 371 Date: Jul. 31, 2009

(30) Foreign Application Priority Data
Mar. 19, 2007 (DE) 20 2007 004184.5

(51) Int. Cl. G06F 17/00; G06K 5/00

(52) U.S. Cl. 235/379; 235/375

(57) ABSTRACT

The invention relates to a self-service device, specifically an automated teller machine, having a display unit to display alphanumeric and/or graphic information, having an operating unit containing a control panel located spaced apart from the display unit to input numeric characters and/or control data and having a plurality of control keys extending in the area of one edge of the display unit and assigned in each case to a display panel of the display unit, wherein the control keys are integrated in a control bar, wherein adjacent control keys are located directly next to each other and wherein the control keys have a length greater than the individual display panels such that the control keys can be assigned in each instance to display panels of several differently configured display units.

The invention relates to a self-service device, specifically an automated teller machine, having a display unit to display alphanumeric and/or graphic information, an operating unit containing a control panel located spaced apart from the display unit to enter numeric characters and/or control data, and a plurality of control keys extending in the area of one edge of the display unit and assigned in each case to one display panel of the display unit.

Self-service devices, such as automated teller machines, have a display unit to display alphanumeric and/or graphic information as well as an operating unit by means of which numeric characters and/or control data can be entered. Usually, the operating unit has a control panel spaced apart from the display unit with a plurality of numeric keys so that, after inserting a bank card into a card slot of the automated teller machine, a personal identification number (PIN) serving to identify the card holder can be entered. The operating unit has in addition a number of control keys positioned in the vicinity of the display unit so that it is easier for the user to enter the amounts of money. These control keys correspond in each case to a display panel in the display unit in which a specified amount of money, such as [symbol] 50, [symbol] 100, [symbol] 150, . . . [symbol] 500, is shown. The desired amount of money can be selected and the bank card and the appropriate bank notes then dispensed by operating a control key assigned to the corresponding display panel. Control keys that are disposed spaced apart from each other in the vicinity of the display unit are known from DE 20 2005 003 396 U1. In order to ensure that the specific control keys are unambiguously assigned to the display panels in the display unit, the display panels in the display unit must be disposed equidistant from each other. Usually, it is desirable to distribute the display panels evenly along one lateral edge of the display unit so that the display area can be optimally used in the case of display units with dimensions of different sizes. However, this requires that the spacing of the control keys from each other be selected differently, depending on the dimensions of the display unit, to permit an unambiguous correlation between the corresponding display fields and control keys.

The object of the invention is accordingly to refine a self-service device having a display unit and an operating unit in such a way that the configuration of control keys in the operating unit assigned to a display unit is simplified, so that said keys can be used for differently dimensioned display units.

To achieve this object, the invention, in conjunction with the preamble of claim 1, is characterized in that the control keys are integrated in a control bar, where adjacent control keys are positioned immediately next to each other and where the control keys have a length greater than the individual display panels such that the control keys can be assigned to display panels of several differently dimensioned display units.

The particular advantage of the invention is that, even in the case of differently dimensioned display units, a direct correlation between the corresponding control keys and the display panels in the display unit is always ensured. The control bar in accordance with the invention allows it to be integrated into automated teller machines that have, for example, display units with a 12-, 15- or 17-inch screen. The basic concept of the invention is to select the size of the area for assigning the control keys, i.e. the length of said keys, large enough so that they can be assigned to a number of display panels spaced apart from each other differently.

In accordance with a preferred embodiment of the invention, the length of the control keys and/or the maximum difference of the distance between centers of adjacent display panels to the length of the control keys is selected such that the height of one display panel does not intersect with that of a control key. Consequently, misinterpretation by the customer when correlating the control keys with the display panels is reliably prevented. At the same time, the control bar can be used for a large number of differently dimensioned display units.

In accordance with a further embodiment of the invention, the control keys are of a length that corresponds to the mean of a minimum distance between centers of adjacent display panels of a first small screen and a maximum distance between centers of adjacent display panels of a second large screen of the display units. This ensures that the control bar can be combined with display units of a large number of differently dimensioned screens.

In accordance with a further embodiment of the invention, the control bar is configured as a separate structural unit that is joined to a surround bounding the screen of the display unit. The operating unit can advantageously be of modular construction and attached in the locations provided for installation in the vicinity of the display unit.

In accordance with a further embodiment of the invention, the control bar is attached on an upper side of the surround bounding the screen, with the control bar extending at least flush to a lateral edge of the surround running along one side facing the screen area. The control keys are thus located advantageously in the immediate proximity of the display fields of the display unit. Consequently, it is easier for the customer to assign the control keys to the corresponding display panel.

In accordance with a further embodiment of the invention, the control bar is bonded to the surround of the display unit. As a result, the existing surround of the display unit can be advantageously used to attach the control bar.

In accordance with a further embodiment of the invention, each control key has a first key leg and a second key leg, where the second key leg extends into the vicinity of the screen surface. Errors in parallax that result from the relatively thick, or curved, screen are thereby prevented.

In accordance with a further embodiment of the invention, a dividing seam is formed between adjacent control keys that is a different color from the top surface of the control keys. This is advantageous in achieving a simple, visual separation of the control keys.

Further advantages of the invention can be found in the additional dependent claims.

One embodiment of the invention is explained in greater detail in what follows using the drawings.

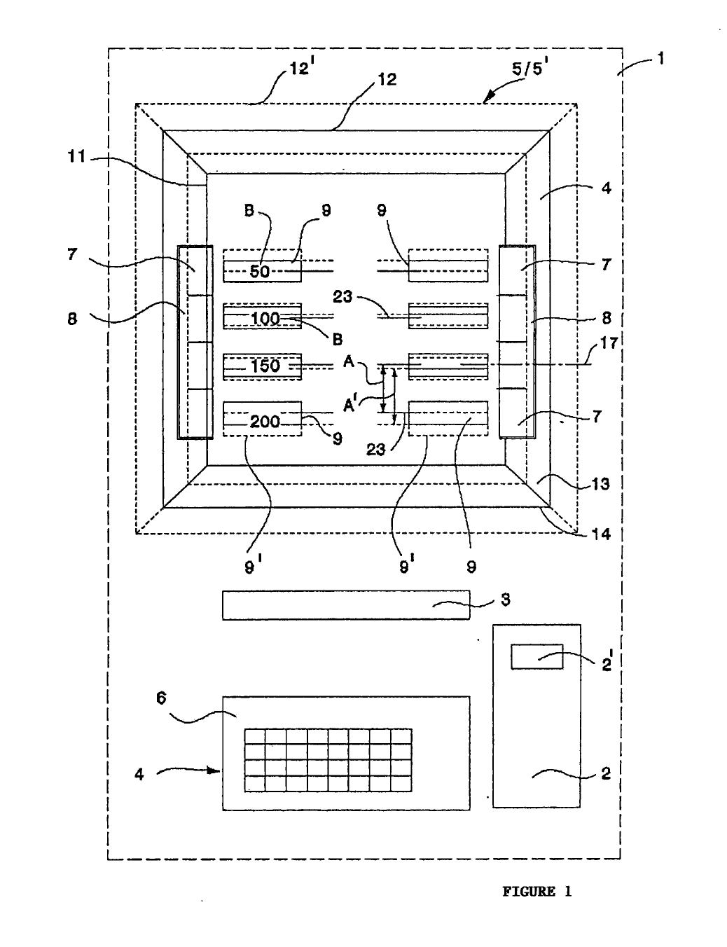

FIG. 1 shows a schematic front view of the display unit with a plurality of display panels disposed in rows and control bars assigned to the rows and attached to vertical sections of the surround of the display unit,

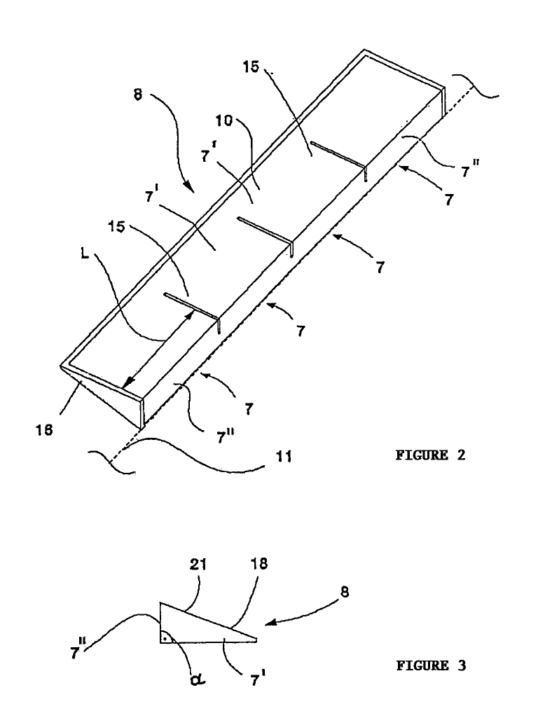

FIG. 2 shows a perspective view of a control bar and

FIG. 3 shows a plan view of the control bar.

A self-service device configured as an automated teller machine 1 includes a housing in which, or on which, are disposed a card reader 2 with a card slot 2′ for inserting a bank card, a money dispensing unit 3 to dispense bank notes, an operating unit 4 for the customer to enter numbers and/or control data, and a display unit 5 for displaying alphanumeric and/or graphic information.

The operating unit 4 has first an operating panel 6 spaced apart from the display unit 5 in which a numeric keypad is integrated for entering numeric characters. For example, a personal identification number (PIN) or a an amount of money to be withdrawn from a bank account can be entered thereon.

Secondly, the operating unit 4 has a plurality of control keys 7 that are combined to form a control bar 8 extending in a straight line. The control bar 8 comprises in the present embodiment four control keys 7 that are assigned in each case to a graphic representation of display panels 9 created by means of a money dispensing control program installed in the computer of the automated teller machine 1. The display panels 9 preferably serve to display amounts of money B, such as “50”, “100”, “150”, “200”, “300”, “400”, “500”, “other amount”. This simplifies the entry of amounts of money to be withdrawn since the numeric characters of the amount B are not enabled by actuating the control panel 6 but only by pressing a single control key 7 on the control bar 8 assigned to the corresponding display panel 9.

In order to assign the control bar 8 to the specific display fields 9 unambiguously and reliably, the control keys 7 on the control bar 8 are positioned in the immediate vicinity of the display panels 9 disposed in a row.

The control keys 7 with their cover 10 extend up to one edge 11 of a screen 12 of the display unit 5.

The control bar 8 is preferably configured as a separate structural unit that is attached on an upper side 13 of a surround 14 of the display unit 5, depending on the size of the screen 12 and/or the positioning of the display panels 9 determined by the software. The control keys 7 disposed in a row are only separated from each other along the linear extension of the control bar 8 by a dividing seam 15. Because the dividing seam 15 is a different color from the cover 10 of the control keys 7, the card holder can recognize the dimension of the control keys 7. The control keys 7 are all of the same length L, where inner control keys 7′ are bounded by the dividers 15 running perpendicular to the extension of the control bar 8 and outer control keys 7″ are bounded by a divider 15 and an end face 16 of the control bar 8.

The cover 10 of the control keys 7 may be configured in one piece. For example, the cover 10 can consist of a spring steel material, where switch elements (not shown) are located in the area of a center plane 17 of the control key 7 below said center plane. These switches can comprise, for example, a pliant trigger element with downstream electronics so that when the specific control keys 7 are pressed, an actuating signal is generated.

As can be seen more clearly from FIGS. 2 and 3, the control keys 7 have a first key leg 7′ and a second key leg 7″ disposed at an interior angle α offset to said first key leg. The first key leg 7′ is disposed essentially parallel to the surface of the screen 12. The second key leg 7″ is disposed essentially perpendicular to the surface of the screen 12. The interior angle α may be a right angle, for example. Alternatively, the interior angle α can also lie in a range between 60° and 120°.

Because the control keys 7 have relatively short angled edges (second key leg 7″), the control keys 7 can extend right up to the surface of the screen 12. Because the divider 15 not only separates the first key legs 7′ from each other but also the second key legs 7″ of the adjacent control keys 7, the control keys 7 can be better assigned to the display panels 9 while preventing parallax errors. The screen 12 is understood to comprise not only the actual screen surface of the display unit 5, but also a cover plate completing the display unit 5.

The control bar consists of a plastic housing, which is triangular in cross-section, in which switch elements are located in the area of the center planes 17 of the control keys 7. The opening of the housing 18 is covered by the one-piece covers 10 of the control keys 7. The control bar 8 is attached on the upper side 13 of the surround 14 bounding the screen 12. The control bar 8 can, for example, be attached by the adhesive application of a back side 21 of said control bar to the upper side 13 of the surround.

In accordance with an alternative embodiment, the control bar 8 can also have fastening elements by means of which the control bar 8 engages behind the surround 14 to retentively attach said control bar to the surround.

The second key legs 7″ in the installed position run flush to one lateral edge of the surround 14 so that the impression is given to the observer that the specific display panels 9 merge into the corresponding control keys 7.

The control keys 7 are positioned immediately next to each other and in a row, whereby they have a same length L. The length L of the control keys 7 is selected such that it is possible to assign the control keys 7 to display panels 9 of differently dimensioned screens 12. For example, the length L of the control keys 7 is selected such that allocation to the display fields 9 of 12-inch, 15-inch, 17-inch or 19-inch screens is ensured. It is assumed in this that the display panels 9 of a screen of a certain size have a same distance between centers A or A′ from each other, where the distance between centers A or A′ is determined by the distance of the center planes 23 of adjacent display panels 9.

So that a direct allocation of the display panels 9 to the corresponding control keys 7 is ensured, without a partial area of a display panel 9 being disposed at the height of a control key 7 adjacent the corresponding control key 7, the length L of the control keys 7 is selected such that the distance between centers A or A′ lies within a specified deviation Δfrom the length L of the control key 7. The following conditions apply:

A′ₘₐₓ≧L+Δ,

A′ₘᵢₙ≧L−Δ,

wherein A′ₘₐₓ is the maximum distance between centers of adjacent display panels 9 with a relatively large screen and A′ₘᵢₙ is the minimum distance between adjacent display panels 9 with a relatively small screen.

If this condition is not met, the result is an undesirable intersecting of display panels 9 and control keys 7, which could result in erroneous operation by the customer.

The center lines 23 of the display panels 9 preferably lie to the greatest extent possible on a line with corresponding center planes 17 of the control keys 7. If there is a minimum distance between centers A′ₘᵢₙ of 4 cm with a relatively small sized screen, and a distance between centers A′ₘₐₓ of 6 cm with a relatively large sized screen, the length L of the control keys 7 is determined by the ratio

$$L = \frac{{A}_{max}^{′} + {A}_{min}}{2} = 5 cm$$

This ensures that the control keys 7 are positioned to the greatest extent possible to form a relatively small deviation between centers to the corresponding display panels 9.

In the present embodiment the length L of the control keys 7 is 5 cm, so that the control keys 7 can be positioned with a relatively small deviation from the center planes 23 of display panels 9 of differently dimensioned display units 5. In this way, control keys 7 are certain to be assigned relatively reliably to corresponding display panels 9.

A larger screen 12′ of a display unit 5′ that has display panels 9′ with comparatively larger distances between centers A′ is shown in FIG. 1 in addition to the small screen 12. The control keys 7 can be assigned to the differently configured display units 5, 5′ by suitably setting the length L of the control keys 7.

What is claimed is:

1. Self-service device, specifically automated teller machine,
having a display unit to display alphanumeric and/or graphic information,
having an operating unit containing a control panel located spaced apart from the display unit to enter numeric characters and/or control data and
having a plurality of control keys extending in the area of one edge of the display unit and assigned in each case to a display panel of the display unit,
characterized in that the control keys are integrated in a control bar, whereby adjacent control keys are disposed immediately adjacent each other and whereby the control keys have a length greater than the specific display panels such that the control keys can be assigned to specific display panels of several differently configured display units.

2. Self-service device from claim 1, wherein the adjacent display panels have a distance from each other that diverges by a specified maximum deviation from the length of the control keys.

3. Self-service device from claim 1, wherein the length of the control keys and/or the maximum deviation of the distance between centers of the display panels from the length of the control keys is selected such that adjacent display panels in a row of display panels located at a same distance between centers from each other are located solely at the height of the control keys assigned to them in each case.

4. Self-service device from claim 1, wherein the length of the control keys lies in an area that is defined by the minimum distance between centers of a first small screen and a maximum distance between centers of a second large screen.

5. Self-service device from claim 1, wherein the length of the control keys is defined as the mean of the minimum distance between centers of the first small screen and a maximum distance between centers of the second large screen.

6. Self-service device from claim 1, wherein the control bar is configured as a separate structural unit that is attached to a surround of the display unit bounding the screen of said display unit.

7. Self-service device from claim 1, wherein the control bar is attached on an upper side of the surround, wherein the control bar extends at least flush to a lateral edge of the surround running on a side facing the screen.

8. Self-service device from claim 1, wherein the control bar is bonded to the surround of the display unit.

9. Self-service device from claim 1, wherein the control keys of the control bar have a first key leg running essentially parallel to the surface of the screen and a second key leg running essentially perpendicular to the surface of the screen, wherein the second key leg extends as far as the vicinity of the lateral edge of the surround.

10. Self-service device from claim 1, wherein the first key leg and the second key leg have an included interior angle in the range of 60° to 120°, preferably 90°.

11. Self-service device from claim 1, wherein a cover of the first key leg and a cover of the second key leg are joined in one piece.

12. Self-service device from claim 1, wherein a dividing seam is formed between the adjacent control keys on the control bar that is a different color from the top surfaces of the control keys.
